(19) United States
(12) Patent Application Publication
(10) Pub. No.: US 2018/0013575 A1
(43) Pub. Date: Jan. 11, 2018

(54) INFORMATION SUCCEEDING METHOD, INFORMATION SUCCEEDING SYSTEM, AND INFORMATION PROCESSING APPARATUS

(71) Applicant: FUJITSU LIMITED, Kawasaki-shi (JP)

(72) Inventors: Naoya FUJISAKI, Yokohama (JP); Akira ITASAKI, Yokohama (JP); Naoki NISHIGUCHI, Kawasaki (JP); Akira FUJII, Machida (JP)

(73) Assignee: FUJITSU LIMITED, Kawasaki-shi (JP)

(21) Appl. No.: 15/694,010

(22) Filed: Sep. 1, 2017

Related U.S. Application Data
(63) Continuation of application No. PCT/JP2015/057184, filed on Mar. 11, 2015.

(51) Int. Cl. H04L 12/18; H04L 29/06

(52) U.S. Cl. CPC H04L 12/1822; H04L 63/102

(57) ABSTRACT

Disclosed is an information succeeding method executed by a computer. The information succeeding method includes determining whether a context satisfies a predetermined condition; distributing a content to a terminal in a case where the context is determined to satisfy the predetermined condition; transmitting, upon receiving succeeding information indicating succeeding of the content from the terminal, content information corresponding to the succeeding information to the terminal; receiving from the terminal the previously distributed content, based on the content information; and transmitting the previously distributed content to a succeeding destination, upon receiving a content request that has been transmitted from the succeeding destination based on the content information, the content information having been received by the succeeding destination from the terminal.

### CROSS-REFERENCE TO RELATED APPLICATIONS

This application is a continuation application of International Application PCT/JP2015/057184 filed on Mar. 11, 2015 and designated the U.S., the entire contents of which are incorporated herein by reference.

### FIELD

The disclosures discussed herein relate to an information succeeding method, an information succeeding system, and an information processing apparatus.

### BACKGROUND

In recent years, communication terminals such as tablet terminals and smartphones have become widespread, and are utilized in various fields such as transmission and reception of information over the business at companies and the like. For example, in a conference system, for each conference room or each conference, contents such as conference materials are distributed to communication terminals that have been brought into the conference room by attendees, or the distributed contents are collected or deleted from the communication terminals at the time of ending the conference or leaving the conference room. As described above, there is a system that distributes or deletes contents or the like according to context (e.g., situation such as place and time).

### RELATED ART DOCUMENTS

### Related-Art Document

### Patent Document

Patent Document 1: Japanese Laid-open Patent Publication No. 2002-259315

However, when it is desired to continue to use content or the like for a context not satisfying a predetermined condition, a new context needs to be generated for the content to be delivered again according to the generated context. Accordingly, the content, will fail to be continuously used across different contexts.

### SUMMARY

According to one aspect of an embodiment, an information succeeding method executed by a computer is provided. The information succeeding method includes determining whether a context satisfies a predetermined condition; distributing a content to a terminal in a case where the contest is determined to satisfy the predetermined condition; transmitting, upon receiving succeeding information indicating succeeding of the content from the terminal, content information corresponding to the succeeding information to the terminal; receiving from the terminal the previously distributed content, based on the content information; and transmitting the previously distributed content to a succeeding destination, upon receiving a content request that has been transmitted from the succeeding destination based on the content information, the content information having been received by the succeeding destination from the terminal.

The object and advantages of the invention will be realized and attained by means of the elements and combinations particularly pointed out in the appended claims.

It is to be understood that both the foregoing general description and the following detailed description are exemplary and explanatory and are not restrictive of the invention as claimed.

### BRIEF DESCRIPTION OF DRAWINGS

FIG. 1 depicts an example of a schematic configuration of an information succeeding system in a present embodiment;

FIG. 2 depicts a functional configuration example of a server in a first, embodiment;

FIG. 3 depicts a functional configuration example of a terminal in the first embodiment;

FIG. 4 depicts an example of a hardware configuration of a server;

FIG. 5 depicts an example of a hardware configuration of a terminal;

FIG. 6 is a sequence diagram illustrating an example of an information distribution process in an information succeeding system;

FIG. 7 is a sequence diagram illustrating an example of a succeeding event process in the first embodiment;

FIG. 8 is a sequence diagram illustrating an example of a succeeding-exit process in the first embodiment;

FIG. 9 is a sequence diagram illustrating an example of a succeeding-entry process in the first embodiment;

FIG. 10 depicts an example of registration information;

FIG. 11 depicts an example of meta information;

FIG. 12 depicts an example of registration information after the succeeding event;

FIG. 13 depicts an example of registration information in a succeeding destination;

FIG. 14 depicts a functional configuration example of a terminal in a second embodiment;

FIG. 15 is a sequence diagram illustrating an example of a succeeding event process in the second embodiment;

FIG. 16 depicts a functional configuration example of a terminal in a third embodiment;

FIG. 17 is a sequence diagram illustrating an example of a succeeding event process in the third embodiment;

FIG. 18 depicts a functional configuration example of a server in a fourth embodiment;

FIG. 19 depicts a functional configuration example of a terminal in the fourth embodiment; and

FIG. 20 is a sequence diagram illustrating an example of a succeeding event process in the fourth embodiment.

### DESCRIPTION OF EMBODIMENTS

In the following, preferred embodiments are described with reference to the accompanying drawings.

### Schematic Configuration Example of the Information Succeeding System in Present Embodiment

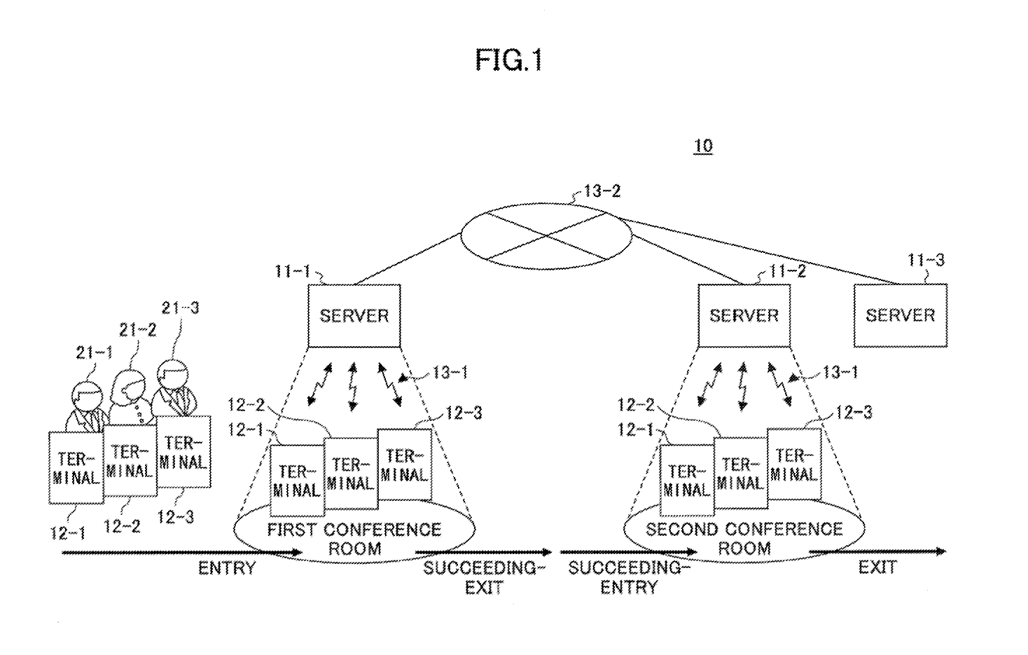

FIG. 1 depicts an example of a schematic configuration of an information succeeding system in a present embodiment. In an example of FIG. 1, the information succeeding system 10 includes one or more servers 11 as an example of an information processing apparatus and one or more terminals 12. The servers 11 and the terminals 12 are connected such that data is enabled to be transmitted and received by a communication network 13-1 typically represented by, for example, a local area network (LAN), the Internet, or the like.

In the information succeeding system 10 illustrated in this embodiment, as depicted in FIG. 1, a server 11 (e.g., a server 11-1, a server 11-2) are provided according to different places (e.g., a first conference room and a second conference room). Note that the information succeeding system 10 does not limit the number of servers 11 to two, and may for example have, as illustrated in FIG. 1, two or more servers including a server 11-3 and the like, so as to implement a later-described information succeeding process and the like between the servers 11. Note that the server 11-3 has the same configuration as the servers 11-1 and 11-2, and specific description of each is omitted for the purpose of convenience. The servers 11 are connected such that data is enabled to be transmitted and received by a communication network 13-2 typically represented by, for example, a local area network (LAN), the Internet, or the like.

The server 11 accumulates data of content scheduled to be distributed set for each conference (which may include an application for viewing, editing and updating the content, hereinafter referred to as “application/content”). Note that the application/content may be an application alone, a content alone such as an image, video, document data or the like, or a combination of an application and a content. The application has various functions such as browsing of contents, addition of comments, page turning, editing such as applying tags and bookmarks, updating, and the like.

The server 11 uses, as a condition to determine data distribution (hereinafter called “distribution determination condition”), a state (context) in which the terminal 12 is located in a predetermined area (e.g., a conference room, a classroom, a test site, and a facility) at a predetermined time to distribute, via the communication network 13-1, electronic data of the application/content to the terminals 12 that satisfy the condition.

For example, when the terminal 12 moves from a first area (a first conference room or the like) to a second area (a second conference room or the like), that is, when the above-described distribution determination condition is changed, information about the currently used data (application/content) is transmitted to the server (a first server) 11-1, and deletes the data such as the application/content distributed at the conference from the terminal 12. The succeeding source server 11-1 transmits the application/content and the like distributed individually via the communication network 13-2 in response to an application/content request from a succeeding destination server (a second server) 11-2.

When the terminal 12 moves from the first conference room to the second conference room, the succeeding destination server 11-2 acquires information such as a succeeding event from the terminal 12 via the communication network 13-1. The succeeding destination server 11-2 matches the application/content and the like that have been browsed and identification information (e.g., terminal ID) of the terminal 12, and makes a request to the succeeding source server 11-1 to transmit the matched application/content and the like to the succeeding destination server 11-2 via the communication network 13-2. Then, the succeeding destination server 11-2 distributes the acquired application request to the terminal 12 via the communication network 13-1.

The terminal 12 performs a process such as receiving input of application/content and the like from the server 11, temporarily transmitting the received data to the server 11, transmitting the data accumulated in the terminal 12 or deleting the application/content according to whether to enter or exit a predetermined area.

For example, there may be a case in which the conference duration may exceed the scheduled end time, but the conference may still be desired to be continued in another conference room in the information succeeding system 10 illustrated in FIG. 1. In such a case, it takes time to newly set a place and time and register the information of the application/content in the succeeding destination server 11-2, and the conference may be interrupted for a long time. In addition, conference materials may contain confidential information and the like, and hence, it is necessary to prevent the conference materials from being unnecessarily taken out.

The information succeeding system 10 performs a succeeding-exit process for allowing the server 11-1 to upload the distributed application/content while leaving the meta information of the registration information in the terminal 12 using a succeeded event trigger or an operation rule set in advance, a security policy (e.g., authorization information) and the like as a trigger. The terminals 12 each having the meta information are recognized as a succeeding-entry at the time of entering the succeeding destination (e.g., the second conference room), the succeeding destination server 11-2 acquires the entity of the application/content stored in the succeeding source server 11-1 based on the meta information of the terminals 12, and then performs an entry process.

In the present embodiment, for example, the terminals 12 may leave the succeeding source and enter the succeeding destination in a normal way, the conference material (application/content) deleted from each of the terminals 12-1 to 12-3 depicted in FIG. 1 may be automatically and safely distributed to the succeeding destination, which may omit labor for registering information to the succeeding destination and labor for accessing the conference materials. Accordingly, users 21-1 to 21-3 possessing the terminals 12-1 to 12-3 may be able to use the application/content even at the destination.

Note that the number of servers 11, the number of terminals 12, the number of users 21, or the like is not restricted to the example depicted in FIG. 1. The server 11 may be a Personal Computer (PC); the server 11 may be, for example, a cloud server configured by cloud computing having one or more information processing apparatuses. Examples of the terminal 12 include, but are not restricted to, a communication terminal such as a tablet terminal, a smartphone, and the like.

The following describes a functional configuration example of the server 11 and the terminal 12 in the information succeeding system 10. Note that the servers 11-1 and 11-2 depicted in FIG. 1 may have a common configuration, and thus, the servers 11-1 and 11-2 may be collectively described as the server 11 in the following description. Further, since the terminals 12-1 to 12-3 may also have a common configuration, the terminals 12-1 to 12-3 will be collectively described as the terminal 12 in the following description.

### First Embodiment

### Functional Configuration of Server 11

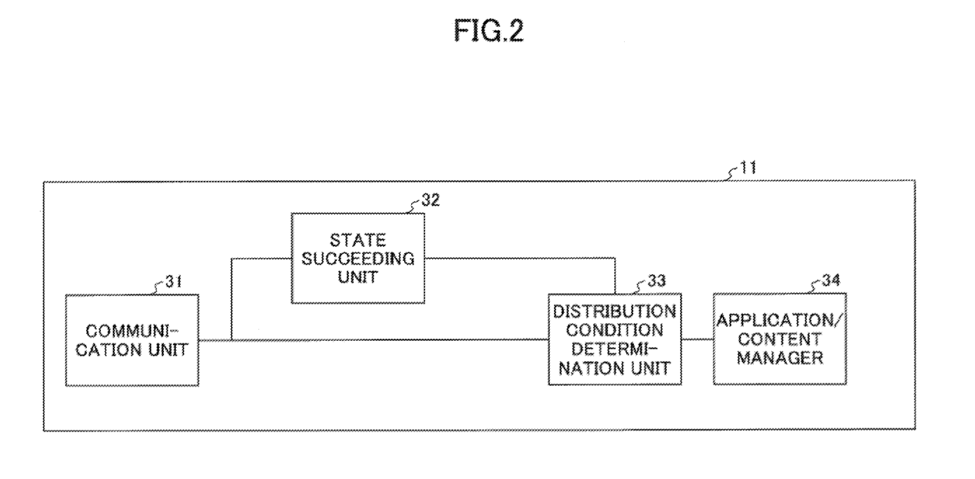

FIG. 2 depicts a functional configuration example of a server in a first embodiment. In the example of FIG. 2, the server 11 includes a communication unit 31, a state succeeding unit 32, a distribution condition determination unit 33, and an application/content manager 34.

The communication unit 31 transmits and receives data to and from each of the terminals 12 through the communication network 13-1. Further, the communication unit 31 transmits and receives registration information, a succeeding application/content, and the like for succession based on meta information from another server 11 or the like via the communication network 13-2 or the like.

The state succeeding unit 32 receives from the terminal 12 via the communication unit 31 a utilization state of the distributed application/content, and stores the received utilization state. Examples of the utilization state include, but are not restricted to, the place where the application/content is used, the server information of the distribution destination, the application/content name, the attendee's information and the like.

For example, when the state succeeding unit 32 receives succeeding information indicating succeeding of application/content from the terminal 12, the state succeeding unit 32 transmits meta information (content information) and the like corresponding to the succeeding information to the terminal 12 via the communication unit. When one server 11 is the succeeding source server 11-1, the state succeeding unit 32 receives distributed content from the terminal 12 based on meta information and the like. Further, for example, the state succeeding unit 32 receives the content information obtained by the succeeding destination server 11-2 from the terminal 12 and receives a content request to be transmitted based on the content information received by the succeeding destination server 11-2. Further, the state succeeding unit 32 performs a process such as transmitting the distributed content corresponding to the received content request to the succeeding destination server 11-2 via the communication unit 31.

In the case where the server 11 is the succeeding destination server 11-2, the state succeeding unit 32 makes an acquisition request (request) of the distributed application/content (succeeding application/content) to the succeeding source server 11-1 to acquire the corresponding application/content.

The distribution condition determination unit 33 determines whether a context satisfies a predetermined condition (e.g., a situation such as a place or time); when the distribution condition determination unit 33 determines that the context satisfies the predetermined condition, the distribution condition determination unit 33 distributes necessary materials for conference such as an application/content to the terminal 12. Examples of the distribution condition include, but are not specifically restricted so conditions such as a time and a place (conference room) fox distributing the application/content, a user (terminal 12) to which the application/content is distributed, and a type of the application/content.

The application/content manager 34 stores meta information for identifying a succeeded state. The application/content manager 34, for example, stores succeeding information and the like from the first conference room to the second conference room as illustrated in FIG. 1; however, the meta information is not restricted to this example.

### Functional Configuration of Terminal 12

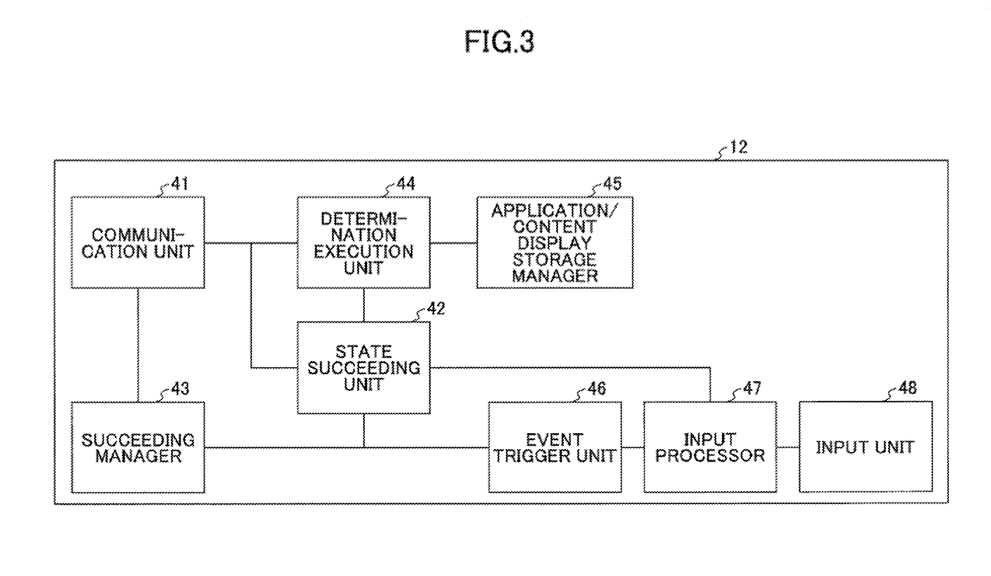

FIG. 3 depicts a functional configuration example of a terminal in the first embodiment. In the example of FIG. 3, the terminal 12 includes a communication unit 41, a state succeeding unit 42, a succeeding manager 43, a determination execution unit 44, an application/content display storage manager 45, an event trigger unit 46, an input processor 47, and an input unit 48.

The communication unit 41 communicates with the server 11. For example, the communication unit 41 transmits terminal information (e.g., a terminal ID) to the server 11 from a place where the communication unit 41 may be enabled to communicate with the server 11 to receive corresponding application/content. Further, in a case of a succeeding event, the communication unit 41 receives meta information from the succeeding source server 11-1. In a case of a succeeding-exit event, the communication unit 41 transmits the distributed application/content to the server 11. In a case of a succeeding-entry event, the communication unit 41 receives the distributed application/content from the server 11.

The state succeeding unit 42 transmits and receives the utilization state of the application/content to and from the server 11. For example, in a case of a succeeding event, the state succeeding unit 42 acquires meta information from the server 11 via the communication unit 41. In a case of a succeeding-exit event, the state succeeding unit 42 uploads the distributed application/content to the server 11 via the communication unit 41. In a case of a succeeding-entry event, the state succeeding unit 42 downloads the uploaded distributed application/content from the server 11 via the communication unit 41.

The succeeding manager 43 manages the succeeding state of the terminal 12 based on the presence or absence of meta information and the like. For example, the succeeding manager 43 acquires meta information from the server 11 via the communication unit 41 such that the application/content within the terminal 12 distributed from the server 11 may also be used in other places or the like. The succeeding manager 43 embeds address information access to the succeeding place information, the succeeding application/content name, the succeeding application/content, and the like in basic meta information obtained from the server 11, and generates meta information for identifying the succeeded state of currently displayed application/content data. In addition, the succeeding manager 43 uploads the embedded meta information to the server 11 via the communication unit 41.

The determination execution unit 44 executes determination such as whether to acquire or delete the application/content. In a case where the determination result satisfies the application/content acquisition condition, the determination execution unit 44 acquires the application/content, and in a case where the determination result, satisfies the application/content deletion condition, the determination execution unit 44 deletes information (entity) of the application/content.

The application/content display storage manager 45 stores and manages the display content of the application/content and the like. The event trigger unit 46 determines whether there is an event corresponding to a predetermined condition based on the input information input via the input unit 48 from the user. An example of the predetermined condition includes, but is not specifically restricted to, a process such as succeeding of application/content.

The input processor 47 outputs the succeeding event to the event trigger unit 46 from the information received from the input unit 48. An example of the information received from the input unit 48 includes, but is not specifically restricted to, information about whether an input for succeeding data has been executed by a user operation. The input unit 48 receives input of various instruction information and the like to be performed on the terminal 12 by the user.

### Hardware Configuration of Server 11

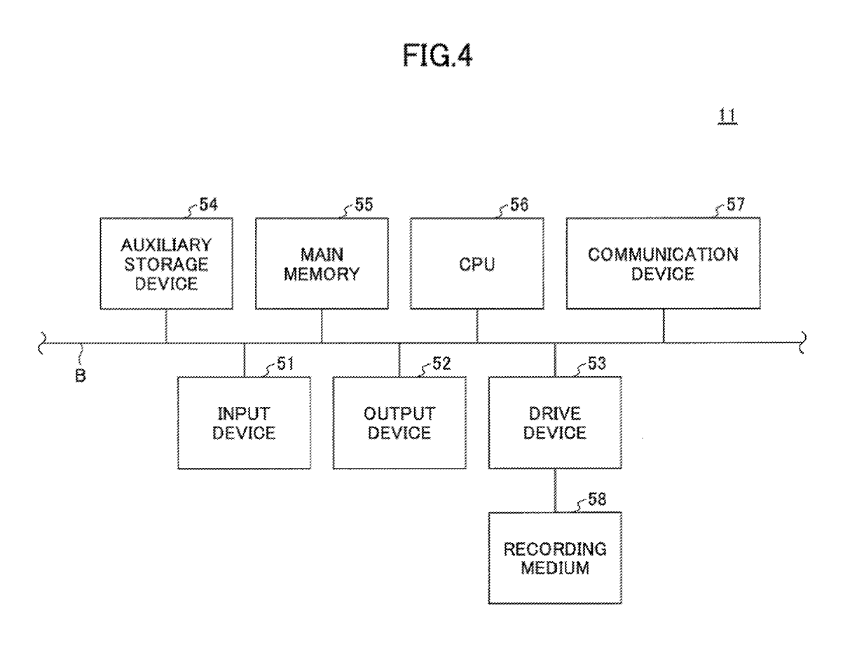

Next, a hardware configuration example of the above-described server 11 will be described with reference to the accompanying drawings. FIG. 4 depicts an example of a hardware configuration of a server. In the example of FIG. 4, the server 11 includes an input device 51, an output device 52, a drive device 53, an auxiliary storage device 54, a main storage device 55, a central processing unit (CPU) 56, and a communication device 57, and these components are mutually connected by a system bus B.

The input device 51 has a keyboard and a pointing device such as a mouse operated by a user, an audio input device such as a microphone, or the like, and is configured to receive input information such as an instruction to execute a program input from the user or the like, various kinds of operation information, information for activating software such as an application and the like.

The output device 52 includes a display configured to display various windows, data, and the like necessary for operating a computer main body (server 11) for performing the process according to the present embodiment. The output device 52 may be enabled to display a progress of execution of the program and the result, and the like, by a control program of the CPU 56.

In the present embodiment, for example, an execution program installed in the computer main body is provided by the recording medium 58 or the like. The recording medium 58 may be set in the drive device 53. Based on the control signal from the CPU 56, the execution program stored in the recording medium 58 is installed from the recording medium 58 to the auxiliary storage device 54 via the drive device 53.

The auxiliary storage device 54 is, for example, a storage unit such as hard disk drive (HDD) or solid state drive (SSD). The auxiliary storage device 54 stores an execution program (e.g., an information succeeding program) in this embodiment, a control program provided in the computer and the like, based on a control signal from the CPU 56, and optionally performs input and output. The auxiliary storage device 54 may be enabled to read or write necessary information from each stored information based on a control signal from the CPU 56 or the like.

The main storage device 55 stores an execution program and the like read from the auxiliary storage device 54 by the CPU 56. The main storage device 55 is a read-only Memory (ROM), a random access memory (RAM), or the like.

The CPU 56 controls processes of the overall computer such as various operations and input/output of data with each hardware component based on a control program such as an operating system (OS) and an execution program stored in the main storage device 55, so as to implement each of the processes. Various information and the like necessary during the execution of the program may be acquired from the auxiliary storage device 54 and may store the execution result and the like.

Specifically, the CPU 56 executes a program installed in the auxiliary storage device 54 based on, for example, a program execution instruction or the like obtained from the input device 51, thereby executing a process corresponding to the program on the main storage device 55. For example, the CPU 56 executes the execution program to perform processes such as communication by the communication unit 31, succeeding of the state by the state succeeding unit 32, determination of distribution conditions by the distribution condition determination unit 33, and the like. The content of processes in the CPU 56 is not restricted to those described above. The content executed by the CPU 56 is optionally stored in the auxiliary storage device 54 or the Like.

The communication device 57 communicates with another external device via a communication network typically represented by, for example, the Internet or a wired/wireless LAN. Based on a control signal from the CPU 56, the communication device 57 acquires an execution program, software, setting information, and the like from an external device or the like by connecting to a communication network or the like. Further, the communication device 57 may provide the external device with an execution result obtained by executing the program, or may provide the external device or the like with the execution program itself in this embodiment.

The recording medium 58 is a computer readable recording medium storing execution programs and the like as described above. Examples of the recording medium 58 include, but are not specifically restricted to, a semiconductor memory such as a flash memory, a removable recording medium such as a CD-ROM, a DVD, or the like.

By installing an execution program (e.g., an information succeeding program) in the hardware configuration depicted in FIG. 4, the hardware resources coordinate with the software to implement information succeeding processes (e.g., succeeding event process, succeeding-exit process, succeeding-entry process) on the server 11 side in this embodiment.

### Hardware Configuration of Terminal 12

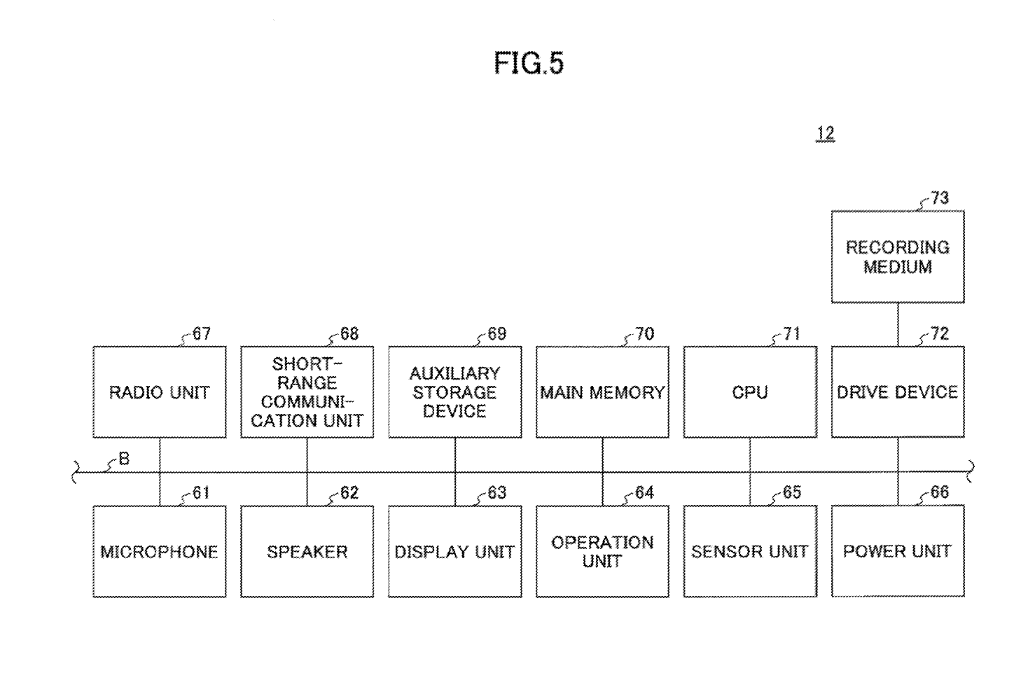

Next, a hardware configuration example of the above-described, terminal 12 will be described with reference to the accompanying drawings. FIG. 5 depicts an example of a hardware configuration of a terminal. In the example of FIG. 5, the terminal 12 includes a microphone 61, a speaker 62, a display unit 63, an operation unit 64, a sensor unit 65, a power unit 66, a radio unit 67, a short-range communication unit 68, an auxiliary storage unit 69, a main storage device 70, a CPU 71, and a drive device 72, which are mutually connected via a system bus B.

The microphone 61 inputs a voice or other sound emitted by a user such as a worker. The speaker 62 outputs voice of a communication counterpart of a call or outputs a sound such as a ringing tone of an incoming call. The microphone 61 and the speaker 62 may be used, for example, when talking with a communication counterpart by a call function or the like; however, the usage of the microphone 61 and the speaker 62 is not particularly restricted to these examples. The microphone 61 and the speaker 62 may be used for inputting and outputting information by voice.

The display unit 63 displays a screen set by the OS and various applications to the user. Further, the display unit 63 may be a touch panel display or the like; in this case, the display unit 63 has a function as an input/output unit.

The display unit 63 is a display such as liquid crystal display (LCD) or organic electroluminescence (EL).

The operation unit 64 indicates operation buttons displayed on the screen of the display unit 63, operation buttons provided outside the terminal 12, and the like. The operation buttons may be, for example, a power button or a sound volume adjustment button, or may be operation keys for character input arranged in a predetermined order.

The user performs a predetermined operation on the screen of the display unit 63, for example, or presses a predetermined operation button on the operation unit 64, and the tap position on the screen is detected by the display unit 63. The display unit 63 may be enabled to display the application execution result, contents, icons, cursors, and the like on the screen.

The sensor unit 65 detects an operation at a certain point of time or continuous operations of the terminal 12. For example, the sensor unit 65 may detect, but is not specifically restricted to, an inclination angle, acceleration, orientation, position, and the like of the terminal 12. Examples of the sensor unit 65 include, but are not specifically restricted to, an inclination sensor, an acceleration sensor, a gyro sensor, a GPS, or the like. The sensor unit 65 further includes, for example, an image sensor or the like as an example of an imaging unit that images an object, an AR marker, or the like in real space.

The power unit 66 supplies power to each of the components of the terminal 12. The power unit 66 may be, but is not specifically restricted to, an internal power supply such as a battery. The power unit 66 may detect the amount of electric energy at all times or at predetermined time intervals, and monitor the remaining amount of the electric energy or the like.

The radio unit 67 is a communication data transmitter-receiver that receives a radio signal (communication data) from the base station using an antenna or the like, and transmits a radio signal to the base station via the antenna. The radio unit 67 may transmit or receive data to or from the server 11 from a base station or the like via the communication network 13.

The short-range communication unit 68 may perform short-range communication with a computer such as another terminal 12 or the like by using a communication technique such as infrared communication, Wi-Fi (registered trademark), Bluetooth (registered trademark) or the like. The radio unit 67 and the short-range communication unit 68 described above are communication interfaces enabling data transmission and reception with other computers via the Internet, a LAN, or the like.

The auxiliary storage device 69 is, for example, a storage unit such as a HDD or a SSD. The auxiliary storage device 69 stores various programs and the like, and optionally inputs or outputs data.

The main storage device 70 stores an execution program or the like read from the auxiliary storage device 69 according to an instruction from the CPU 71 and stores various types of information and the like obtained during the program execution. The main storage device 70 may be, but is not specifically restricted to, a ROM or a RAM.

The CPU 71 controls processes of the overall computer such as various operations, input/output of data with each hardware component and the like based on a control program such as an operating system (OS) and an execution program stored in the main storage device 70, so as to implement each of the processes.

Specifically, the CPU 71 executes a program installed in the auxiliary storage device 69 based on, for example, a program execution instruction or the like obtained from the operation unit 64, thereby executing a process corresponding to the program on the main storage device 70. For example, the CPU 71 executes the information succeeding program to perform processes such as communication by the communication unit 41, succeeding of the state by the state succeeding unit 42, succeeding management by the succeeding manager 43, and determination by the determination execution unit 44 and the like. By executing the information succeeding program, the CPU 71 executes display storage management by the application/content display storage manager 45, event monitoring by the event trigger unit 46, input processing by the input processor 47, reception of input information by the input unit 48, and the like.

The content of processes in the CPU 71 is not restricted to those described above. The content executed by the CPU 71 is optionally stored in the auxiliary storage device 69 or the like.

For example, the drive device 72 may detachably set the recording medium 73 or the like, and may read various types of information recorded on the set recording medium 73 or may write predetermined information in the recording medium 73. The drive device 72 may be, but is not specifically restricted to, a medium load slot or the like.

The recording medium 73 is a computer readable recording medium storing execution programs and the like is described above. The recording medium 73 may be, but is not specifically restricted to, a semiconductor memory such as a flash memory or a removable recording medium such as USB memory.

By installing an execution program (e.g., an information succeeding program) in the hardware configuration depicted in FIG. 5, the hardware resources coordinate with the software to implement information succeeding processes (e.g., succeeding event process, succeeding-exit process, succeeding-entry process) on the terminal 12 side in this embodiment.

### Specific Example of Information Succeeding System 10

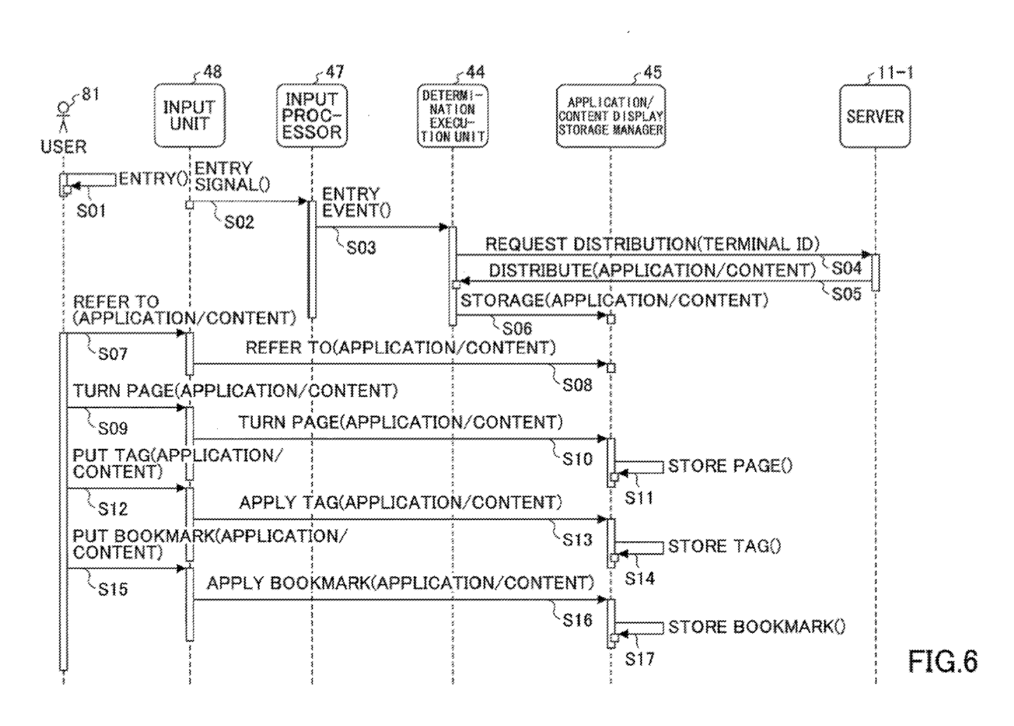

Next, a specific example of the information succeeding system 10 will be described with reference to the accompanying drawings. FIG. 6 is a sequence diagram illustrating an example of an information distribution process in an information succeeding system. The example of FIG. 6 is described by using the input unit 48, the input processor 47, the determination execution unit 44, the application/content display storage manager 45, and the server (e.g., the server 11-1) located within a conference room (e.g., a first conference room).

The example of FIG. 6 illustrates a process in which a user 81 (e.g., the above-described user 21) enters a conference room and uses the application/content distributed from the server 11-1. When the user 81 enters the conference room (S01), the terminal 12 owned by the user 81 detects the access point directed to the radio communication network 13-1 and connects to the detected access point. Next, with the network connection as a trigger, the input unit 48 outputs a signal of entering a room to the input processor 47 (S02).

The input processor 47 outputs the signal as an entry event to the determination execution unit 44 (S03). The determination execution unit 44 determines an entrance/exit event as an acquisition request of the application/content to be used in the conference and makes a distribution request to the server 11-1 (S04). At this time, terminal identification information (e.g., terminal ID) is assigned to the distribution request.

Subsequently, the determination execution unit 44 receives distribution of the application/content and the like from the serve 11-1 (S05) and requests the application/content display storage manager 45 to store the distributed application/content (S06). The application/content display storage manager 45 stores the application/content, and displays the content or the stored application/content on the screen of the terminal 12.

When the user 81 refers to (browses) the application/content displayed on the screen of the terminal 12 by, for example, touching the screen, the touched content is received by the input unit 48 (S07), and the received content is output to the application/content display storage manager 45 (S08). Further, when the user 81 performs an operation of turning over the page of the application/content displayed on the screen of the terminal 12, the input unit 48 receives the operation content (S09), and outputs information corresponding to the received content (e.g., page information) to the application/content display storage manager 45 (S10). The application/content display storage manager 45 stores the content (number of pages) (S11).

When the user 81 performs an operation to apply a tag on the application/content displayed on the screen of the terminal 12, the input unit 48 receives the operation content (S12) and outputs the received content to the application/content display storage manager 45 (S13). The application/content display storage manager 45 stores the content (number of pages) (S11).

When the user 81 performs an operation to apply a bookmark on the application/content displayed on the screen of the terminal 12, the input unit 48 receives the operation content (S15), and outputs the received content to the application/content display storage manager 45 (S16). The application/content display storage manager 45 stores the content (bookmark information) (S17).

That is, the user 81 may perform editing such as turning over a page, applying a tag and a bookmark, or the like to, for example, an application/content distributed during the conference. The application/content display storage manager 45 saves each of the editing contents described above. Note that the processes of S09 to S11, S12 to S14, and S15 to S17 may be optionally performed by the user 81, such that for the user not performing the above operations, the corresponding processes will not be performed accordingly.

### Succeeding Event Process Example in First Embodiment

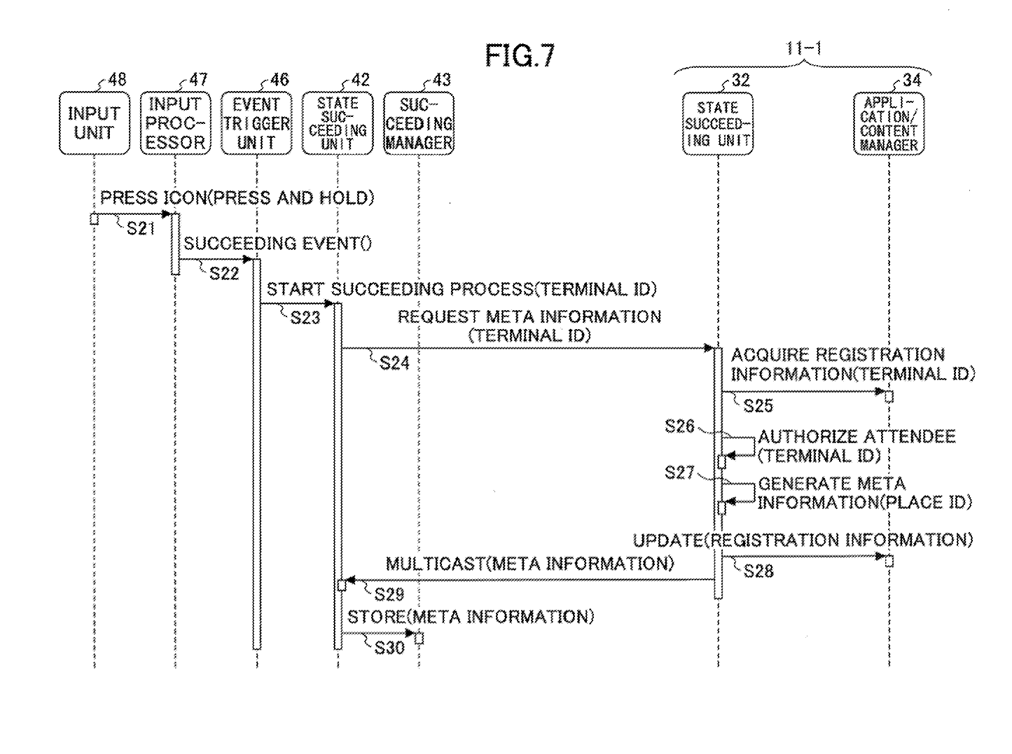

Next, an example of a succeeding event process in the first embodiment will be described with reference to a sequence diagram. FIG. 7 is a sequence diagram illustrating an example of a succeeding event process in the first embodiment. The following describes an example of FIG. 7 with reference to the input unit 48, the input processor 47, the event trigger unit 46, the state succeeding unit 42 and the succeeding manager 43 of the terminal 12, and the state succeeding unit 32 and the application/content manager 34 of the server 11-1.

In the example of FIG. 7, the input unit 48 receives a predetermined operation on the screen of the terminal 12 (e.g., long pressing of an icon for a predetermined number of seconds or more) (S21). The input processor 47 determines whether the received operation is an input for a succeeding event based on the input content, and outputs the succeeding event to the event trigger unit 46 when the received operation is an input for a succeeding event (S22). The event trigger unit 46 generates a start signal of the succeeding process corresponding to the terminal ID, and transmits the generated start signal to the state succeeding unit 42 (S23). The state succeeding unit 42 transmits succeeding information to the state succeeding unit 32 of the server 11 to request meta information (S24). In the process of S24, the terminal ID is transmitted together with the terminal ID.

The state succeeding unit 32 of the server 11-1 acquires registration information from the application/content manager 34 in response to a request for meta information received from the terminal 12 (S25). Next, the state succeeding unit 32 performs an attendee's authentication with respect to the terminal ID (S26), and generates meta information based on place information (e.g., a place ID) (S27). In the process of S27, for example, the number of attendees (terminal ID) obtained from the registration information is automatically generated in a fixed form.

Next, the state succeeding unit 32 updates the registration information with respect to the application/content manager 34 (S28). Next, the state succeeding unit 32 transmits meta information (application/content information) to the terminal 12 by multicast (S29). In the process of S29, after the meta information is generated in the process of S27, the same meta information may be transmitted to other terminals included in the registration information and the like. Accordingly, a representative (chairperson, leader) of the conference executes the succeeding event, process illustrated in FIG. 7, thereby also transmitting (multicasting) the meta information to the other terminals 12 registered in the registration information. Note that the succeeding event process described above may be performed for each terminal 12.

The state succeeding unit 42 of the terminal 12 that has received the meta information transmitted from the server 11 stores the meta information in the succeeding manager 43 (S30). The meta information is used to succeed a state of the application/content that is a conference material, and is managed by the succeeding manager 43. As a result, the terminal 12 is in the succeeding state.

### Succeeding-Exit Process Example

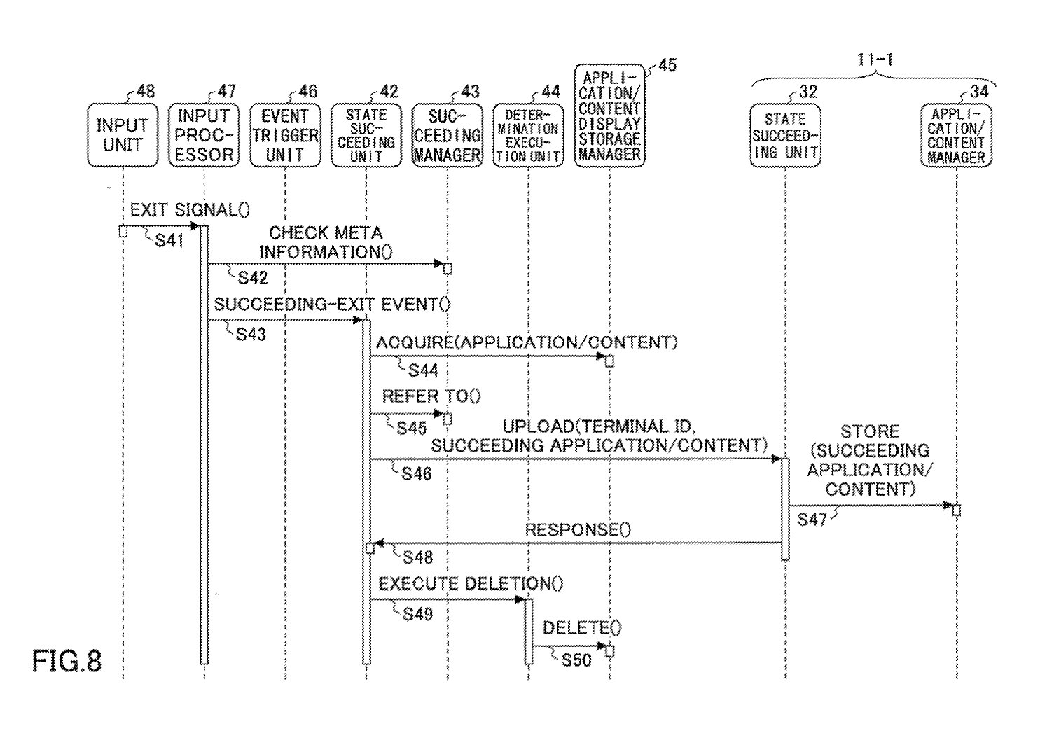

Next, an example of a succeeding-exit process will be described with reference to a sequence diagram. FIG. 8 is a sequence diagram illustrating an example of a succeeding-exit process in the first embodiment. The following describes an example of FIG. 8 with reference to the input unit 48, the input processor 47, the event trigger unit 46, the state succeeding unit 42 and the succeeding manager 43 of the terminal 12, and the state succeeding unit 32 and the application/content manager 34 of the server 11-1.

In the example of FIG. 8, upon receiving a signal of exiting the conference room (first conference room), the input unit 48 outputs a signal (exit signal) accompanying leaving the conference room or the like to the input processor 47 (S41). Next, the input processor 47 sends an inquiry to the succeeding manager 43 to check whether the meta information has already been acquired from the server 11-1 and stored in the server 11-1 (S42). The input processor 47 performs a succeeding-exit event with respect to the state succeeding unit 42 (S43).

The state succeeding unit 42 refers to the application/content display storage manager 45 to acquire a current state (utilization state) of the application/content, and the like (S44). In the process of S44, editing contents such as, but not specifically limited to, turning pages, applying tags, applying bookmarks, and the like may be acquired with respect to application/content distributed during the conference.

Subsequently, the state succeeding unit 42 refers to the succeeding manager 43 to acquire meta information (S45), and uploads the current state to the state succeeding unit 32 of the server 11 (S46). The uploaded content includes, for example, a terminal ID, application/content information (succeeding application/content) to be succeeded, and the like. In a case where the succeeding application/content is edited and updated, the edited and updated application/content includes information such as the page number being referenced, the part to which the tag is applied, the part to which the bookmark is applied, and the like.

The state succeeding unit 32 the server 11 stores the succeeding application/content in the application/content manager 34 in association with the terminal ID obtained from the terminal 12 (S47). Next, the state succeeding unit 32 transmits response information indicating that storage has been completed to the state succeeding unit 42 of the terminal 12 (S48).

The state succeeding unit 42 instructs the determination execution unit 44 to execute data deletion accompanying leaving (exiting) the conference room (S49). The determination execution unit 44 deletes data (e.g., application/content distributed at the time of entering the conference room) present in the application/content display storage manager 45 (S50).

### Succeeding-Entry Process Example

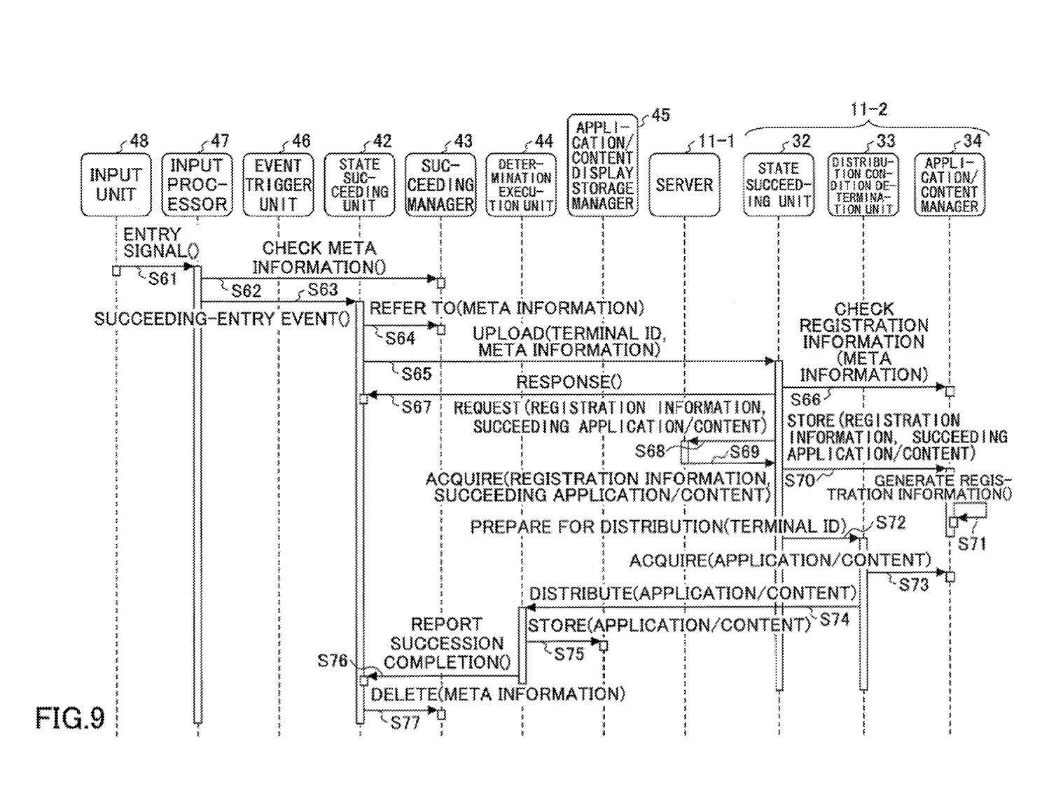

Next, a processing (succeeding-entry process) of entering another conference room will be described with reference to a sequence diagram. FIG. 9 is a sequence diagram illustrating an example of a succeeding-entry process in the first embodiment. The following describes an example of FIG. 9 with reference to the input unit 48, the input processor 47, the event trigger unit 46, the state succeeding unit 42 and the succeeding manager 43 of the terminal 12; the succeeding source server 11-1; and the state succeeding unit 32, a distribution condition determination unit and the application/content manager 34 of the succeeding destination server 11-2.

In the example of FIG. 9, when the input unit 48 of the terminal 12 receives a signal of, for example, entering a conference room (second conference room) (S61), the input processor 47 checks the meta information with respect to the succeeding manager 43 (S62). The input processor 47 outputs a succeeding-entry event to the state succeeding unit 42 (S63).

The state succeeding unit 42 refers to the meta information from the succeeding manager 43 (S64); when there is meta information, the state succeeding unit 42 uploads the terminal ID and the meta information to the server 11-2 (S65). The state succeeding unit 32 of the server 11-2 checks the registration information in the application/content manager 34 based on the uploaded terminal ID and meta information (S66), and transmits response information to the state succeeding unit 42 of the terminal 12 (S67).

Next, the state succeeding unit 32 uses the registration information of the succeeding source obtained from the meta information, the address information of the storage destination of the succeeding application/content, and the like to transmit, to the server 11-1 acting as the succeeding source, registration, information, a request for acquiring application/content and the like (an application/content request) (S68). The server 11-1 transmits the registration information and the succeeding application/content corresponding to the application/content request obtained from the succeeding destination server 11-2 to the state succeeding unit 32 of the succeeding destination server 11-2. As a result, the state succeeding unit 32 acquires the registration information and the succeeding application/content corresponding to the application/content request from the succeeding source server 11-1 (S69).

Next, the state succeeding unit 32 stores the registration information and the succeeding application/content in the application/content manager 34 (S70). The application/content manager 34 generates registration information based on the stored information and the like (S71).

Next, the state succeeding unit 32 prepares for distribution based on the terminal ID, and outputs the information (terminal ID etc.) to the distribution condition determination unit 33 (S72). The distribution condition determination unit 33 acquires the application/content corresponding to the terminal ID from the application/content manager 34 (S73), and distributes the acquired information (application/content) to the determination execution unit 44 of the terminal 12 (S74).

The determination execution unit 44 stores the information delivered from the succeeding destination server 11-2 in the application/contents display storage manager 45 (S75). Next, the determination execution unit 44 outputs a succeeding completion report to the state succeeding unit 42 (S76). The state succeeding unit 42 reports deletion of the meta information to the succeeding manager 43 and deletes the meta information from the succeeding manager 43 (S77). As a result, the succeeding state of the terminal 12 is terminated.

### Examples of Various Data

Next, examples of various data applied in the first embodiment will be described with reference to the accompanying drawings.

### Registration Information Example

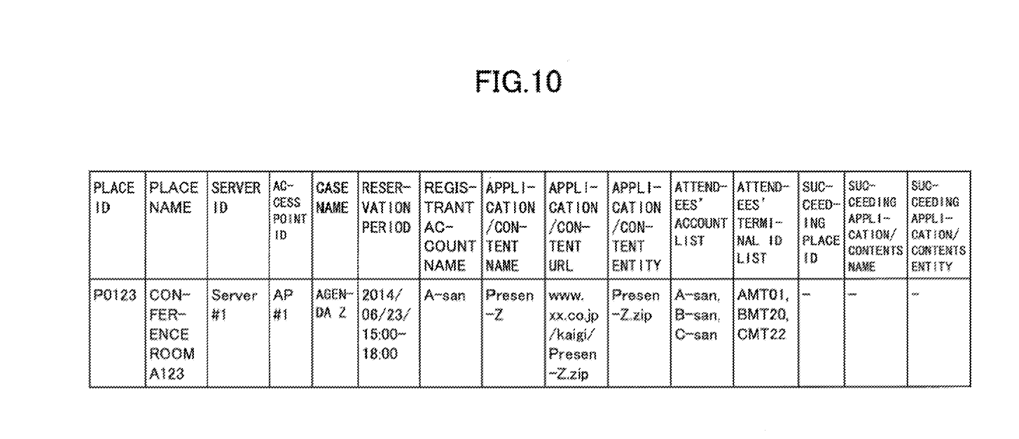

FIG. 10 shows an example of registration information. Examples of the registration information illustrated in FIG. 10 include, but are not restricted to, “place ID”, “place name”, “server ID”, “access point ID”, “case name”, “reservation period”, “registrant account name”, “application/content name”, “application/content URL”, “application/content entity”, “attendees' account list”, “attendees' terminal ID list”, “succeeding place ID”, “succeeding application/content name”, “succeeding application/contents entity”, etc.

The “place ID” is identification information for identifying a place where application/content is distributed. The “Place name” indicates a name of the place corresponding to the place ID. Note that the “place name” may be latitude and longitude information.

The server ID” is identification information of a server disposed in an area of a delivery destination. The “access point ID” is identification information of an access point for performing communication.

The “case name” is a name for a conference or the like. The “reservation period” is date and time information for using the conference room. The “registrant account name” is identification information of a user who registered this registration information. The “application/content name” is a name of the application/content to be distributed when a distribution condition is met. The “application/content URL” is address information (e.g., UniformResourceLocator (URL)) of a storage destination of the application/content to be distributed.

The “application/content entity” is entity information of application/content. The attendees' account list is information indicating attendees of this conference. Note that the application/content is distributed to the attendees indicated in this attendees' account list. The “attendees' terminal ID list” includes identification information of the terminal 12 corresponding to each of the attendees.

The “succeeding place ID” is information tor specifying the location of the succeeding source in a case of succeeding. The “succeeding application/content name” is information on the application/content to be succeeded. The “succeeding application/content entity” is entity information of the succeeding application/content.

Since the example of FIG. 10 indicates registration information before being succeeded, the “succeeding place ID”, “succeeding application/content name”, and “succeeding application/content entity” are blank.

### Meta Information Example

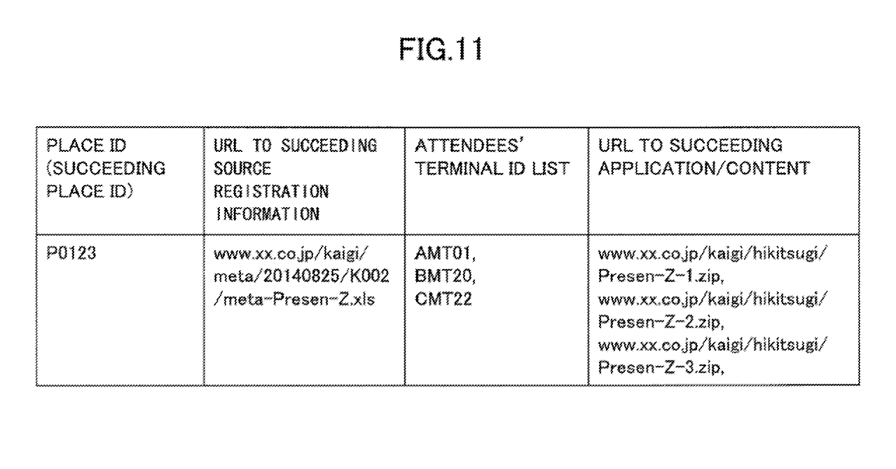

FIG. 11 depicts an example of meta information. Examples of the meta information depicted in the example of FIG. 11 include, but are not specifically restricted to, a “place ID (succeeding place ID)”, “URL directed to succeeding source registration information”, “attendees' terminal ID list”, “succeeding application/content URL”, and the like.

The “place ID (succeeding place ID)” is identification information of a targeted succeeding place. The “URL directed to succeeding source registration information” is address information (e.g., URL) to succeeding source registration information in a case of succeeding of application/content by the succeeding process. The “attendees' terminal ID list” includes list information of identification information (attendees' terminal IDs) of the terminals 12 of the attendees used by one or each of multiple attendees. In the example of FIG. 11, the attendees' terminal ID list includes three attendees' terminal IDs “AMT01”, “BMT20”, and “CMT22”.

The “succeeding application/content URL” is address information (e.g., URL) of a storage destination of the application/content to be distributed. Since the information items of the succeeding application/content, such as the position of the tag, the position of the bookmarker, the number of pages being displayed, and the like are different between the terminals 12, such information items are stored for each attendee's terminal ID list. In the example of FIG. 11, a URL is set for each of the three attendees' terminal IDs “AMT01”, “BMT20”, and “CMT22”.

Note that the minimum necessary information of the meta information illustrated in FIG. 11 maybe implemented with only the place ID. The meta information may be a subset of the registration information. Further, as illustrated in FIG. 11, by providing “succeeding application/content URL” and “URL directed to succeeding source server registration information”, it is possible to directly access the data without making an inquiry with the “place ID”. Accordingly, it is possible to improve the efficiency of the succeeding-exit process and the succeeding-entry process described above.

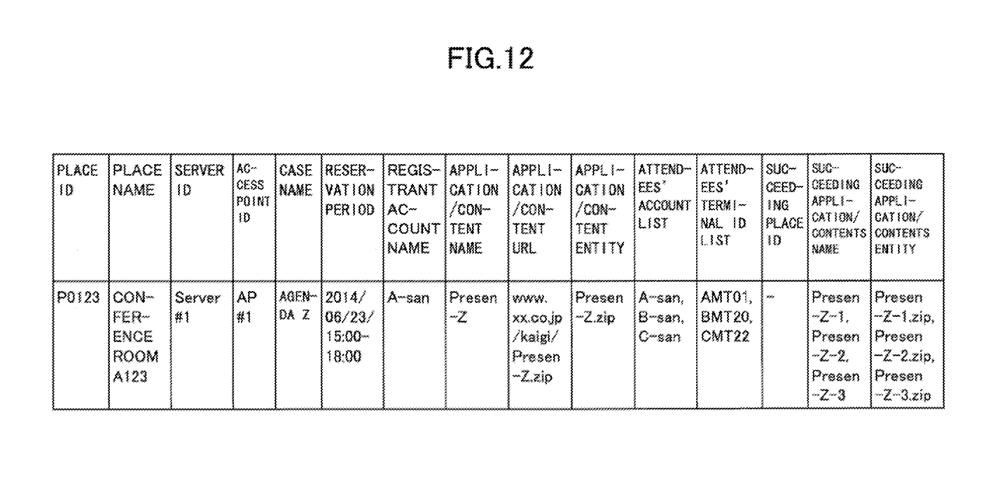

Registration Information Example after Succeeding Event
FIG. 12 depicts an example of registration information after the succeeding event. Since the items of the registration information depicted in FIG. 12 are the same as those of the registration information before the succeeding event illustrated in FIG. 10, a detailed description the registration information of FIG. 12 will be omitted here.

In the example of FIG. 12, information for succeeding is registered in the above-described “succeeding place ID”, “succeeding application/content name”, and “succeeding application/content entity” based on meta information and the like. In the example of FIG. 11, no information is stored in the “succeeding place ID” because such information is registered information in the terminal 12.

The server 11-1 first acquires the registration information currently in use from the application/content manager 34. Next, the server 11-1 performs joining authentication such as whether each terminal is eligible to perform the succeeding process based on the terminal ID, and furthermore, generates meta information as illustrated in FIG. 11 using the place ID or the like in the registration information. Further, the server 11-1 updates, from the registration information of FIG. 10, the registration information as illustrated in FIG. 12. The meta information may be subset information of the registration information. The server 11-1 multicasts the meta information to the terminals 12.

### Registration Information Example in Succeeding Destination Server

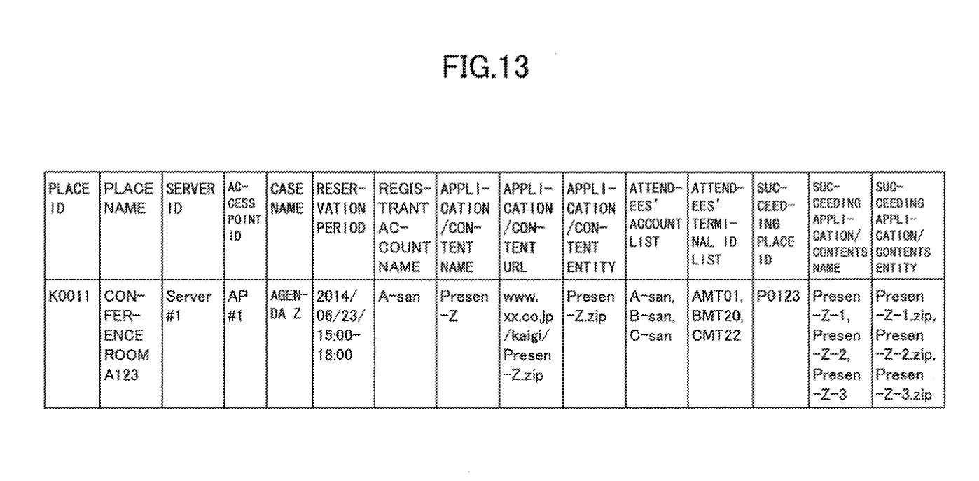

FIG. 13 depicts an example of registration information in a succeeding destination. The items of registration information in FIG. 13 are the same items as those in FIG. 10 described above, and a detailed description of the registration information will be omitted here.

For example, in the server 11-2 acting as the succeeding destination, the state succeeding unit 32 checks the presence or absence of registration information to be matched with the succeeding place ID with respect to the application/content manager 34 based on the uploaded terminal ID and meta information. When there is no corresponding registration information, the server 11-1 acting as a succeeding source is accessed based on the URL directed to the registration information of the succeeding source server 11-1 within the meta information and the information of the succeeding application/content URL directed to acquire the registration information and the succeeding application/content. As a result, the application/content manager 34 may be enabled to generate the registration information of the succeeding destination server as illustrated in FIG. 13.

In the example of FIG. 13, “P0123”, which is the place ID of the succeeding source server, is stored as information related to the “succeeding place ID”, for example, corresponding to the place ID of each terminal.

The material distributed in the first conference room may be continuously used in another conference room (the second conference room) by managing the meta information and the registration information in the above-described manner, for example. For example, when succeeding a conference room, it is unnecessary to newly set the place and time and register the application/content (conference material etc.), and the conference material deleted from the terminal 12 is automatically distributed by simply exiting (leaving) a moving source using some place succeeding event as a trigger and entering a moving destination, thereby saving time and labor to access the conference material.

As described above, according to the first embodiment, the event trigger unit 46 that succeeds the distribution state of the application/content allows the terminal connected to the succeeding destination server 11-2 to restore the distribution state of the application/content of the succeeding source. Hence, according to the first embodiment, it is possible to continuously use application/content across different contexts.

### Second Embodiment

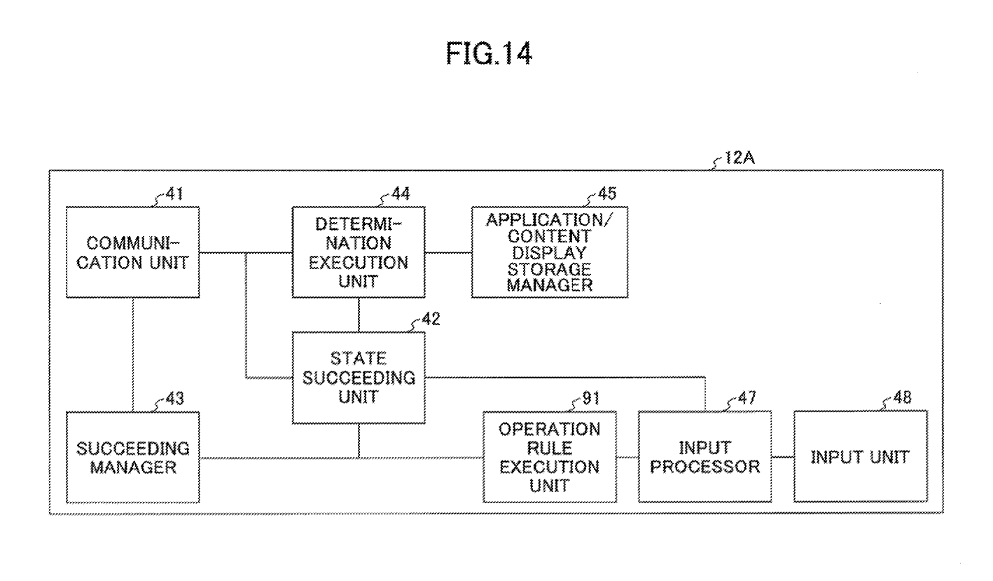

The following describes a second embodiment. FIG. 14 depicts a functional configuration example of a terminal in the second embodiment. In the example of FIG. 14, the same reference numerals are assigned to the same components as those of the above-described first embodiment, and a detailed description the same components will be omitted here.

In the example of FIG. 14, the terminal 12 includes a communication unit 41, a state succeeding unit 42, a succeeding manager 43, a determination execution unit 44, an application/content display storage manager 45, an operation rule execution unit 91, an input processor 47, and an input unit 48. The difference between the second embodiment and the above-described first embodiment is that the second embodiment has an operation rule execution unit 91 instead of the event trigger unit 46.

In the second embodiment, when reporting the succeeding event process to the state succeeding unit 42, for example, the operation rule execution unit 9 reports the succeeding event process in a case where conference operation rules are set in advance in the operation rule execution unit 91 and the setting conditions for the conference operation rules are satisfied.

Note that the configuration example of the information succeeding system, the functional configuration example of the server 11, and the hardware configuration example of a terminal 12A and the server 11 in the second embodiment are the same as those in the above-described first example, and a specific description of these components will thus be omitted here.

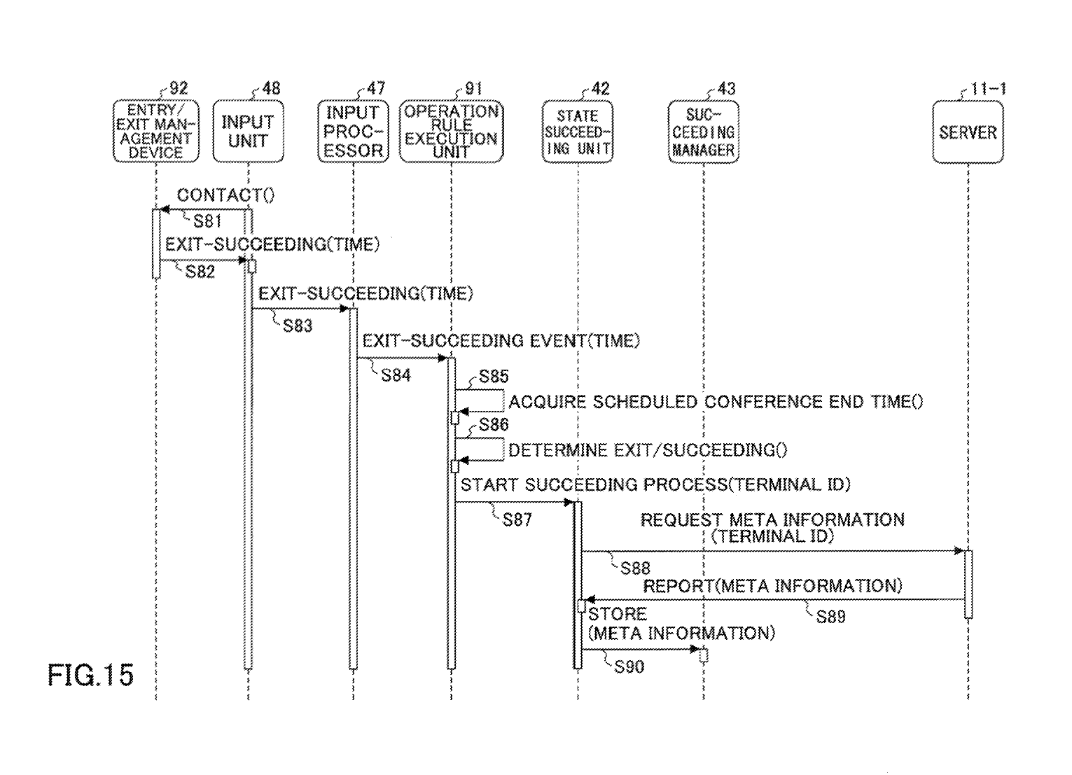

FIG. 15 is a sequence diagram illustrating an example of a succeeding event process in the second embodiment. The example of FIG. 15 will be illustrated with reference to an entry/exit management device 92 configured to manage time of entering and leaving the conference room, an input unit 48, an input processor 47, an operation rule execution unit 91, a state succeeding unit 42, the succeeding manager 43 of the terminal 12A, and the server 11-1.

In the example of FIG. 15, the entry/exit management device 92 is provided in the conference room, and when the terminal 12 enters or leaves the conference room, the terminal 12 is brought into contact with the entry/exit management device 92 to generate an entry/exit event within the terminal 12.

For example, as an example of the operation rule, in the case where an operation rule indicating that “an exit event as of 5 minutes before a scheduled conference end time is treated as a succeeding event” is set in advance, and the terminal 12 is brought into contact with the entry/exit management device 92 or the like (S81), either as of 5 minutes before the scheduled conference end time after the scheduled conference end time has passed, the input unit 48 in the terminal 12 outputs a signal as an exit-succeeding signal (S82) to the input processor 47 (S83). Note that an example of the operation rule is not restricted to the one described above.

The input processor 47 outputs the signal as an exit-succeeding event to the operation rule execution unit 91 (S84). The operation rule execution unit 91 acquires the scheduled conference end time (S85), compares the acquired scheduled end time with the time at which the terminal 12 touches the entry/exit management device 92, and executes determination of exit/succeeding (S86). The scheduled conference end time may be set in advance in the terminal 12 or may be acquired from the server 11-1.

For example, the time at which the terminal 12 is in contact with the entry/exit management device 92 is one minute before the scheduled conference end time, the operation rule execution unit 91 performs determination of succeeding based on the above-described operation rule. Upon determination of the succeeding, the operation rule execution unit 91 reports the start of the succeeding process to the state succeeding unit 42 (S87). The state succeeding unit 42 performs the succeeding process, requests the server 11-1 for meta information corresponding to the terminal ID (S88), and receives a report of meta information from the server 11-1 (S89). Thereafter, the state succeeding unit 42 causes the succeeding manager 43 to store the acquired meta information (S90). Note that the other processes (the succeeding-exit process sequence, the succeeding-entry process sequence, etc.) are the same as those in the first embodiment described above, and a detailed description of these processes will thus be omitted from here. Further, the server 11-2 may have the function of the entry/exit management device 92 described above.

As described above, according to the second embodiment, the operation rule execution unit 91 that succeeds a distribution state of the application/content allows the terminal 12 connected to the succeeding destination server 11-2 to restore the distribution state of the application/content of the succeeding source. Hence, according to the second embodiment, it is possible to continuously use application/content across different contexts.

### Third Embodiment

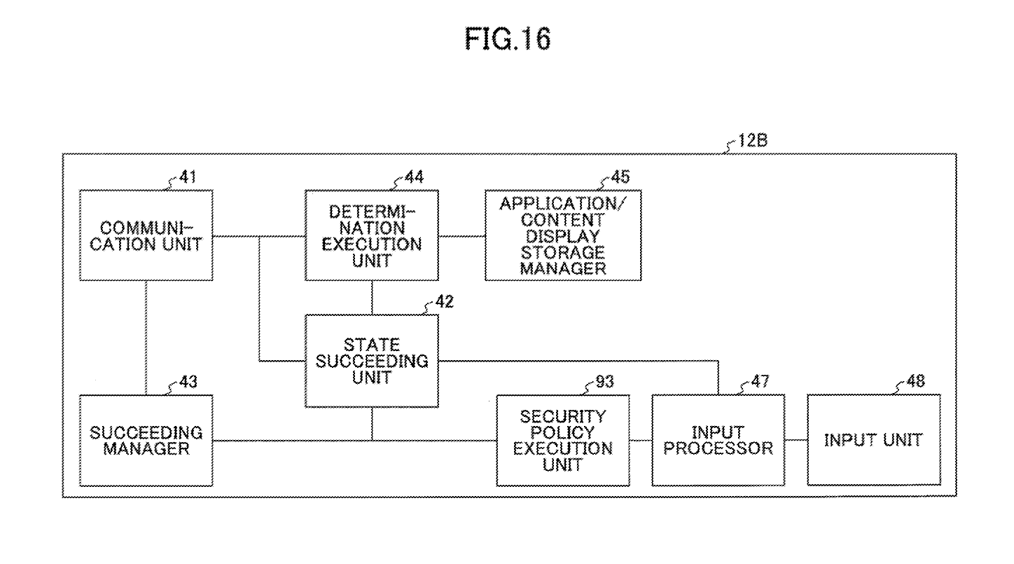

The following describes a third embodiment. FIG. 16 depicts a functional configuration example of a terminal in the third embodiment. In the example of FIG. 16, the same reference numerals are assigned to the same components as those of the above-described first embodiment, and a detailed description of the same components will be omitted from here.

In the example of FIG. 16, a terminal 12B includes a communication unit 41, a stare succeeding unit 42, a succeeding manager 43, a determination execution unit 44, an application/content display storage manager 45, a security policy execution unit 93, an input processor 47, and an input unit 48. The difference between the second embodiment and the above-described first embodiment is that the third embodiment has a security policy execution unit 93 instead of the event trigger unit 46.

The security policy execution unit 93 has set a security policy (e.g., authorization information) of the terminal 12B in advance for reporting the succeeding event process to the state succeeding unit 42. When the security policy satisfies a predetermined condition, the security policy execution unit 93 reports the succeeding event process to the state succeeding unit 42.

Note that the configuration example of the information succeeding system, the functional configuration example of the server 11, and the hardware configuration example of a terminal 12A and the server 11 in the third embodiment are the same as those in the above-described first example, and a specific description of these components will thus be omitted from here.

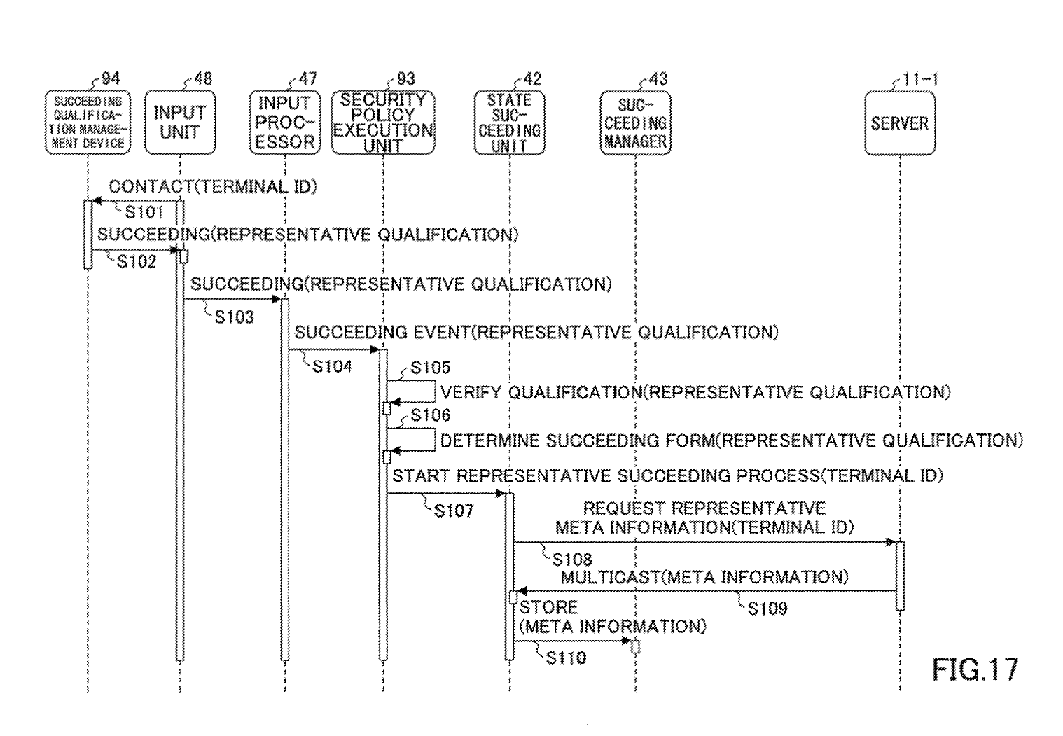

FIG. 17 is a sequence diagram illustrating an example of a succeeding event process in the third embodiment. The example of FIG. 17 will be illustrated with reference to a succeeding qualification management device 94 configured to manage a security policy for the conference room, an input unit 48, an input processor 47, a succeeding qualification management device 94, a state succeeding unit 42, the succeeding manager 43 of the terminal 12B, and the server 11-1.

In the third embodiment, when a representative having a succeeding qualification touches the succeeding qualification management device 94 with his or her terminal 12 before leaving the conference room, a succeeding event is generated within the terminal 12. For example, in a case where there is security policy indicating “the conference is allowed to be succeeded only to the representative having the qualification (authorization)”, such information is managed by the succeeding qualification management device 94.

In such an example, as illustrated in FIG. 17, when a representative having a succeeding qualification touches the succeeding qualification management device 94 with his or her own terminal 12 before leaving the conference room (S101), the input unit 48 acquires authentication information of the representative qualification from the succeeding qualification management device 94 (S102), and outputs the acquired authentication information to the input processor 47 (S103). Note that the method of acquiring the authentication information is not restricted to the one described above; authentication information may be set in advance in the server 11-1 and may be acquired later from the server 11-1, for example.

Next, the input processor 47 outputs the acquired authentication information as a succeeding event to the security policy execution unit 93 (S104). The security policy execution unit 93 performs verification of the representative qualification (S105), and performs the determination of the succeeding form (S106). In the process of S105, verification is performed as to whether the representative corresponding to the terminal ID is authorized to execute the succeeding event process on behalf of other attendees. When determination is made to perform a representative succeeding process as a result of the authentication information, the security policy execution unit 93 outputs the start of the representative succeeding process to the state succeeding unit 42 (S107).

The state succeeding unit 42 performs a representative succeeding process, transmits a request for acquiring representative meta information to the server 11-1 based on the terminal ID (S108), and acquires meta information from the server 11-1 by multicasting (S109). In the example of S109, the meta information is also distributed to the terminals of the other members of the representative. Subsequently, the state succeeding unit 42 causes the succeeding manager 43 to store the acquired meta information (S110). Note that the other processes (the succeeding-exit process sequence, the succeeding-entry process sequence, etc.) are the same as those in the first embodiment described above, and a detailed description of these processes will thus be omitted from here. Further, the server 11-2 may have the function of the succeeding qualification management device 94 described above.

As described above, according to the second embodiment, the security policy execution unit 93 that succeeds a distribution state of the application/content allows the terminal 12 of the representative connected to the succeeding destination server 11-2 to restore the application/content of the succeeding source. Hence, according to the third embodiment, it is possible to continuously use application/content across different contexts.

### Fourth Embodiment

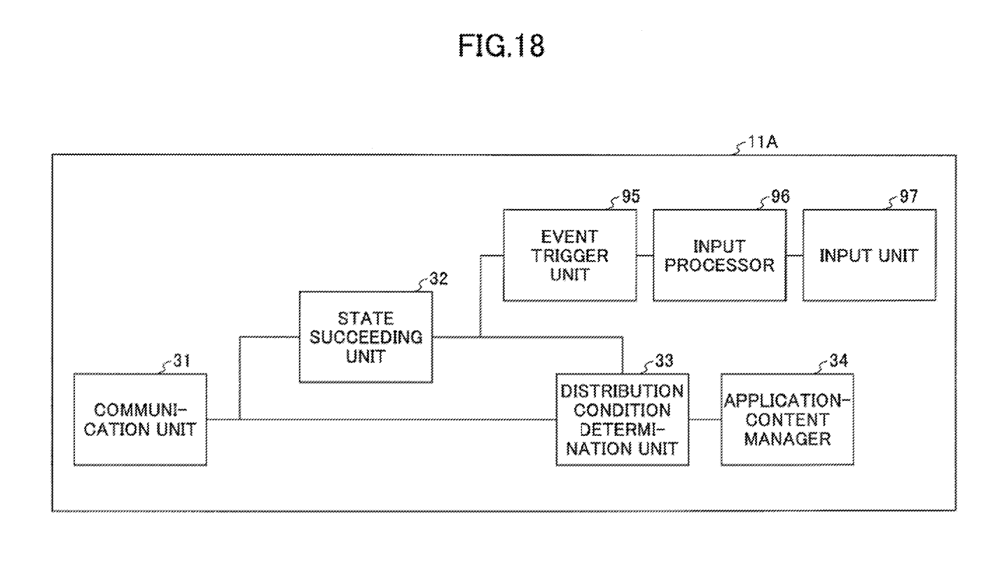

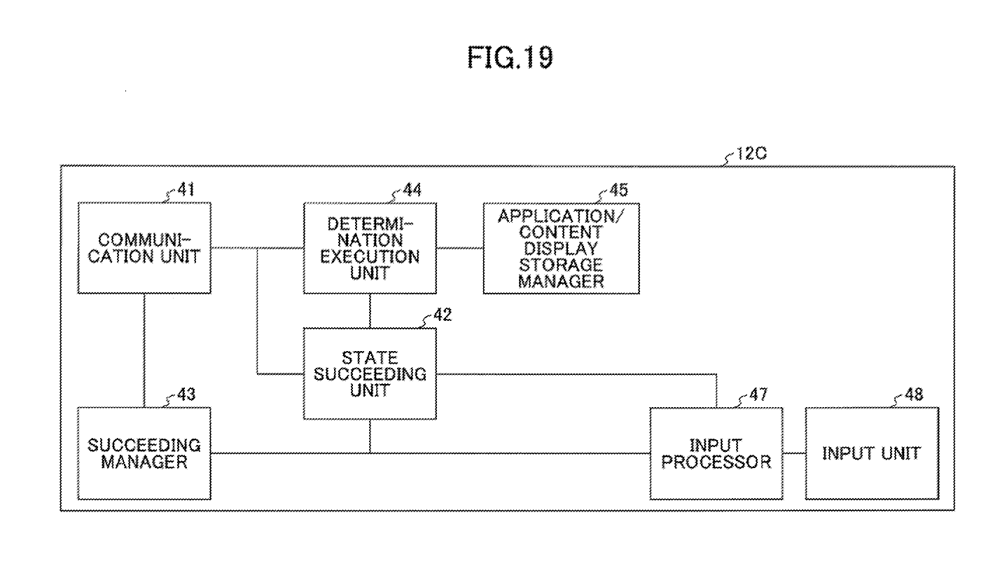

The following describes a fourth embodiment. FIG. 18 depicts a functional configuration example of a server in a fourth embodiment. FIG. 19 depicts a functional configuration example of a terminal in the fourth embodiment. In the examples of FIGS. 18 and 19, the same reference numerals are assigned to the same components as those of the above-described first embodiment, and a detailed description the same components will be omitted from here.

In the example of FIG. 18, the server 11A includes a communication unit 31, a state succeeding unit 32, a distribution condition determination unit 33, an application/content manager 34, an event trigger unit 95, an input processor 96, and an input unit 97. In the example of FIG. 19, the terminal 12C includes a communication unit 41, a state succeeding unit 42, a succeeding manager 43, a determination execution unit 44, an application/content display storage manager 45, an input processor 47, and an input unit 48.

Note that the configuration example of the information succeeding system, and the hardware configuration example of a terminal 12C and the server 11A in the fourth embodiment are the same as those in the above-described first example, and a specific description of these components will thus be omitted from here.

The difference between the fourth embodiment and the above-described first embodiment is that the event trigger unit disposed in the terminal 12 in the first embodiment is provided in the server 11A in the fourth embodiment. Further, in the fourth embodiment, in addition to the event trigger unit 95, an input processor 96 and an input unit 97 are provided in the server 11A. In comparing with the first embodiment, the terminal 12C does not have an event trigger unit in the fourth embodiment.

For example, in the fourth embodiment, a representative (e.g., chairperson) of a conference or the like performs a predetermined operation such as pressing a conference succeeding button provided in advance in the server 11A. Upon receiving the above operation, the input unit 97 handles the received operation as the succeeding event information in the input processor 96, and the event trigger unit 95 outputs the succeeding event process to the state succeeding unit 32. Thereafter, by the communication between the terminal 12C and the server 11A, the same process as in the first to third embodiments described above is executed, and the succeeding application/content described above is also acquired in the conference room or the like of a movement destination.

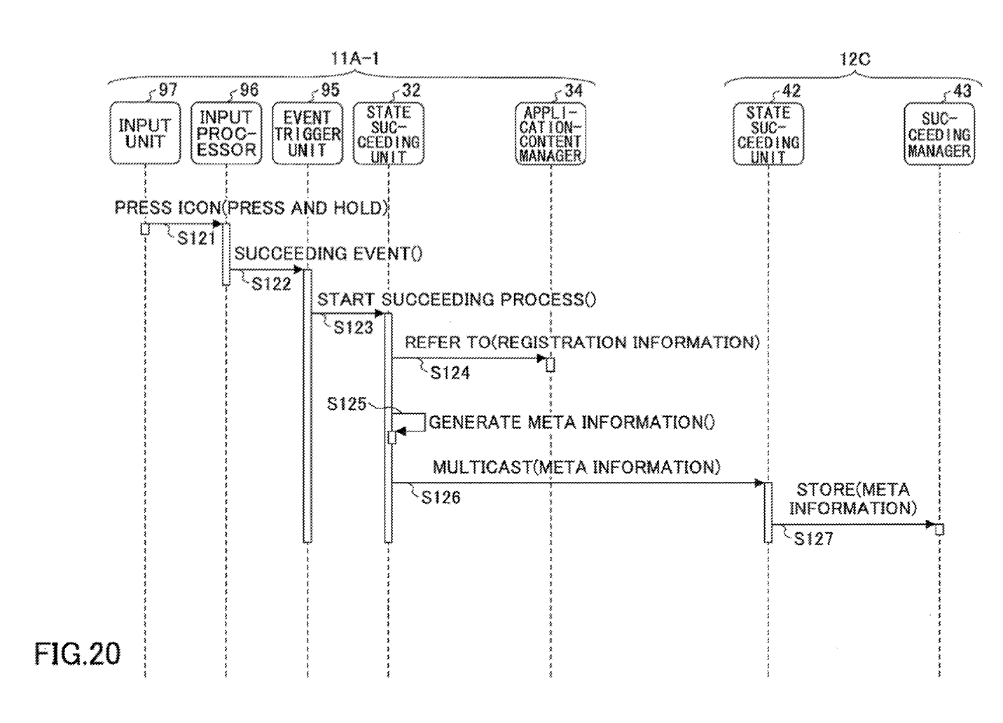

FIG. 20 is a sequence diagram illustrating an example of a succeeding event process in the fourth embodiment. The following describes an example of FIG. 20, with reference to the input unit 97, the input processor 96, the event trigger unit 95, the state succeeding unit 32, and the application/content manager 34 of the succeeding source server 11A-1, the state succeeding unit 42, and the succeeding manager 43 of the terminal 12C.

In the example of FIG. 20, the input unit 97 receives a predetermined operation (e.g., press and hold the conference succeeding button (icon) displayed on the screen for a predetermined number of seconds) on the screen of the server 11A performed by a user (e.g., a representative of a conference) (S121).

Subsequently, the input processor 96 determines whether the received operation is an input for a succeeding event based on the input content, and outputs the succeeding event to the event trigger unit 95 when the received operation is an input for a succeeding event (S122). The event trigger unit 95 generates a start signal of the succeeding process, and transmits the generated start signal to the state succeeding unit 32 (1S23).

Next, the state succeeding unit 32 refers to the currently used registration information managed by the application/content manager 34 (S124), and generates meta information based on the place information (e.g., the place ID) (S125). Note that the registration information is also updated in the process of S125. Subsequently, the state succeeding unit 32 multicasts the meta information (application/content information) to the target terminal 12C indicated in the attendee's terminal ID list of the current registration information (S26). Accordingly, a representative (chairperson, leader) of the conference executes the succeeding event process illustrated in FIG. 20, thereby also transmitting (multicasting) the meta information to all the terminals 12C registered in the registration information. The state succeeding unit 42 of the terminal 12C that has received the meta information transmitted from the server 11 stores the meta information in the succeeding manager 43 (S127). Note that the other processes (the succeeding-exit process sequence, the succeeding-entry process sequence, etc.) are the same as those in the first embodiment described above, and a detailed description of these processes will thus be omitted from here.

As described above, according to the fourth embodiment, the above-described succeeding event process may be achieved by performing a predetermined operation on the server.

### Another Embodiment

As another embodiment, instead of the event trigger unit 95 illustrated in the fourth embodiment, the operation rule execution unit in the above-described second embodiment may be provided in the server 11A. Further, as another embodiment, the security policy execution unit in the above-described third embodiment may be provided in the server 11A. According to such a configuration, it is possible to report the succeeding event process to the state succeeding unit in the server 11A.

In addition, some or all of the above-described embodiments may be combined. For example, in the server 11 or the terminal 12, two or more of the above-described event trigger units, security policy execution units, operation rule execution units may be disposed.

Hence, according to another embodiment, it is possible to continuously use application/content across different contexts. For example, when succeeding a conference room, it is unnecessary to newly set the place and time and register the application/content, and it is possible to succeed the application/content across the places (areas) of the conference rooms or the like.

In addition, according to the above-described embodiment, by using a predetermined succeeding event as a trigger or by applying an operation rule or a security policy, it is possible to simply leave the moving source and enter the moving destination in a conventional way so as to automatically distribute the application/content. Accordingly, it is possible to omit or skip the troublesome operation to access the application/content from the terminal 12. Further, according to the above-described, embodiment, even when a place (conference room) is changed into another place, the conference will not be interrupted for a long time.

Moreover, according to the above-described embodiment, a non-transitory computer-readable storage medium storing an information succeeding program which, when executed by a processor, causes a computer to perform a process including determining whether a context satisfies a predetermined condition; distributing a content to a terminal in a case where the context is determined to satisfy the predetermined condition; transmitting, upon receiving succeeding information, indicating succeeding of the content from the terminal, content information corresponding to the succeeding information to the terminal; receiving from the terminal the previously distributed content, based on the content information; and transmitting the previously distributed content to a succeeding destination, upon receiving a content request that has been transmitted from the succeeding destination based on the content information, the content information having been received by the succeeding destination from the terminal.

In one aspect, an object of an embodiment of the present invention is to enable continued use of content across different contexts.

According to an aspect, of the embodiment, it is possible to continuously use application/content across different contexts.

The embodiments of the present invention have been described in detail above; however, the present invention is not limited to a specific one of the embodiments, and various modifications and changes may be made within the scope described in the claims. In addition, it is also possible to combine part or all of the above-described embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

What is claimed is:

1. An information succeeding method executed by a computer, the information succeeding method comprising:
determining whether a context satisfies a predetermined condition;
distributing a content to a terminal in a case where the context is determined to satisfy the predetermined condition;
transmitting, upon receiving succeeding information indicating succeeding of the content from the terminal, content information corresponding to the succeeding information to the terminal;
receiving from the terminal the previously distributed content, based on the content information; and
transmitting the previously distributed content to a succeeding destination, upon receiving a content request that has been transmitted from the succeeding destination based on the content information, the content information having been received by the succeeding destination from the terminal.

2. The information succeeding method as claimed in claim 1, wherein
the previously distributed content indicates a content edited or updated by each user, and the edited or updated content is managed for each user.

3. The information succeeding method as claimed in claim 1, further comprising:
receiving the succeeding information transmitted from the terminal in a case where an operation performed by a user on the terminal is an event that has been set in advance.

4. The information succeeding method as claimed in claim 1, further comprising:
receiving the succeeding information transmitted from the terminal based on an operation rule that has been set in advance with respect to a current place of the terminal.

5. The information succeeding method as claimed in claim 1, further comprising:
transmitting content information corresponding to the succeeding information to the terminal upon receiving the succeeding information from a user having a predetermined authorization, based on authorization information with respect to the user who uses the terminal.

6. The information succeeding method as claimed in claim further comprising:
receiving an operation performed by a user from an input unit, and receiving the succeeding information transmitted from the terminal in a case where the received operation is an event that has been set in advance.

7. The information succeeding method as claimed in claim 1, further comprising:
the content information corresponding to the succeeding information including targeted succeeding place information, identification information of the terminal, and address information of a storage destination of the previously distributed content.

8. An information succeeding system comprising:
a first server configured to distribute content to a terminal in a first area; and
a second server that distributes content to a terminal in a second area, the first server and the second server being connected via a communication network, wherein
the first server includes a memory and one or more processors programmed to execute a process including:
determining whether a context satisfies a predetermined condition;
distributing a content to a terminal in a case where the context is determined to satisfy the predetermined condition;
transmitting, upon receiving succeeding information indicating succeeding of the content from the terminal, content information corresponding to the succeeding information to the terminal;
receiving from the terminal the previously distributed content, based on the content information; and
transmitting the previously distributed content to the second server acting as a succeeding destination, upon receiving a content request that has been transmitted from the second server based on the content information, the content information having been received by the second server from the terminal.

9. An information processing apparatus comprising a memory and one or more processors programmed to execute a process including:
determining whether a context satisfies a predetermined condition;
distributing a content to a terminal in a case where the context is determined to satisfy the predetermined condition;
transmitting, upon receiving succeeding information indicating succeeding of the content from the terminal, content information corresponding to the succeeding information to the terminal;
receiving from the terminal the previously distributed content, based on the content information; and transmitting the previously distributed content to a succeeding destination, upon receiving a content request that has been transmitted from the succeeding destination based on the content information, the content information having been received by the succeeding destination from the terminal.
